(19) United States
(12) Patent Application Publication
(10) Pub. No.: US 2017/0003311 A1
(43) Pub. Date: Jan. 5, 2017

(54) Method for Detecting Bicycle Pedaling Frequencies

(71) Applicant: SHENG-CHIA OPTICAL CO., LTD., Taipei (TW)

(72) Inventors: Jinn-Yuan LAY, Taipei (TW); Shih Yuan KUO, Taipei (TW)

(21) Appl. No.: 14/789,762

(22) Filed: Jul. 1, 2015

(51) Int. Cl. G01P 1/07; B62J 99/00

(52) U.S. Cl. CPC G01P 1/07; B62J 99/00; B62J 2099/002; B62J 2099/0026

(57) ABSTRACT

The present invention provides a method for detecting bicycle pedaling frequencies, in which an accelerometer of the body is used to detect the acceleration value of the pedal during pedaling, and the processing unit determines the periodical variations on acceleration increases and decreases, records the acceleration waveform, calculates the number of cycling in the pedal per minute based on the times that the sampled values within a unit time cross over the central line of the acceleration value, and also transfers tempo data to an electronic device by way of a wireless communication circuit and displays the pedaling frequency of the pedal via a screen so as to allow a user to promptly appreciate relevant information during riding and facilitate appropriate adjustments and controls on pedaling tempo and force.

### BACKGROUND OF THE INVENTION

1. Field of the Invention

The present invention provides a method for detecting bicycle pedaling frequencies; in particular, the present invention discloses a method for detecting bicycle pedaling frequencies which uses an accelerometer of the body to detect the acceleration value of the pedal during pedaling, and a processing unit can calculate the pedaling frequency data of the pedal and transfer to an electronic device by way of a wireless communication circuit in order to display the pedaling frequency of the pedal on a screen.

2. Description of Related Art

It is very common to set up a bicycle meter on a bicycle to show the riding mileage, duration of time and/or speed, and some of such bicycle meters may also display information like pedaling frequency and/or heart beat rate and so forth. Herein the pedaling frequency may concern the cycling tempo and force on the bicycle pedal during riding, so users would generally select bicycle meters having the pedaling frequency detection function specifically with regards to pedaling trainings.

However, the pedaling sensor currently used on bicycles mainly applies the electro-magnetic induction principle, which includes essentially a magnetic object (e.g., a magnet, a reed etc.) as well as a sensor (e.g., a Hall component, a sensor coil or the like), and the magnetic object is installed on the crank or chain wheel of the bicycle while the sensor installed on the bicycle frame (such as the seat supportive rod or the rear lower fork etc.) thereby that the sensor can detect the time when the magnetic object rotates along with the crank or chain wheel and continuously passes over the sensor, and accordingly calculate the number of cycling per minute in order to complete the pedaling frequency detection during pedaling. Nevertheless, this type of pedaling sensor requires precise alignments between such separate elements, i.e., the magnetic object and the sensor, so as to detect the pedaling frequency data, and that means the magnetic object needs to be placed very closely to the installation position of the sensor so that the sensor can reliably detect the magnetic object's passing over. In most cases, since the magnetic object and the sensor are respectively fixed to a location on a bicycle in correspondence with each other merely by means of a binding belt or a buckler, during riding, the bicycle may be easily shocked and moved due to external impact forces thus causing deviations between the locations of the magnetic object and the sensor and negatively affecting the stability of data detections; therefore, corrections may be required thus resulting in troubles for users during riding and training. As such, it becomes an issue to be researched and improved by those skilled ones in relevant fields.

### SUMMARY OF THE INVENTION

The primary objective of the present invention is to use an accelerometer of the body to detect the acceleration value of the pedal during pedaling in accordance with the physical principle on acceleration variations in a simple harmonic motion, and a processing unit can determine the periodical change along acceleration increases and decreases and calculate the central value of acceleration in each unit time. In case the detected acceleration value changes from being greater than the central value to smaller than the lower index level of the central value, it is determined that the acceleration waveform crosses over the central line of the acceleration value for one (1) time. Next, it calculates the cycling number of the pedal per minute based on the number of times that the acceleration crosses over the central line from high to low in a unit time, and updates the central value of acceleration and the motion position data. Then, it uses a wireless communication circuit to transfer data to an electronic device and displays the pedaling frequency of the pedal on a screen.

Moreover, the secondary objective of the present invention is to use the processing unit to determine the effective number that the sampled acceleration values cross over the central line, which sets a reference value based on the sampling frequency and determines as a cross-over in case the sampled effective number reaches the reference value so as to prevent erroneous determinations such as the wave peak suddenly formed due to abrupt acceleration waveforms caused by instantaneous acceleration actions, acceleration value changes because of forward-backward tilting in treading gestures on the pedal, as well as pedal flipping and crossing over the central line of acceleration or the like, thus ensuring correction and stability in data detections.

Yet another objective of the present invention is to allow the installation of the body on a bicycle pedal and the connection of the accelerometer, the processing unit and the wireless communication circuit to a power source which may be a button cell battery for reduced volume, such that the body can provide convenient usage and be integrally formed on the pedal without requiring precise alignments, the original function of the pedal may not be affected, and in practice the deviation issue resulting from vibrations or other external forces can be well addressed so as to ensure integral features and effects.

### BRIEF DESCRIPTION OF THE DRAWINGS

FIG. 1 shows a block diagram of the present invention.

FIG. 2 shows a diagram for the application of the present invention on a bicycle pedal.

FIG. 3 shows a utilization status diagram for a preferred embodiment of the present invention.

FIG. 4 shows a step flowchart (1) of the present invention.

FIG. 5 shows a step flowchart (2) of the present invention.

FIG. 6 shows a diagram for the acceleration waveform of the present invention.

FIG. 7 shows a step flowchart for updating the central value of the acceleration according to the present invention.

FIG. 8 shows a step flowchart for determining whether the acceleration value crosses over the central line according to the present invention.

FIG. 9 shows a step flowchart for updating the pedal position according to the present invention.

FIG. 10 shows a step flowchart for transferring the pedaling frequency data of the pedal during pedaling according to the present invention.

### DETAILED DESCRIPTION OF THE PREFERRED EMBODIMENTS

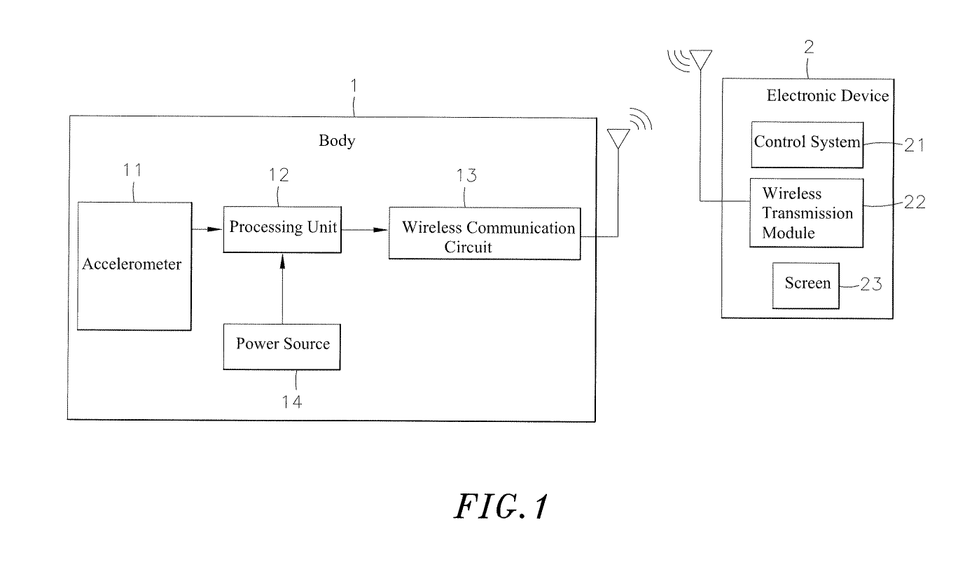

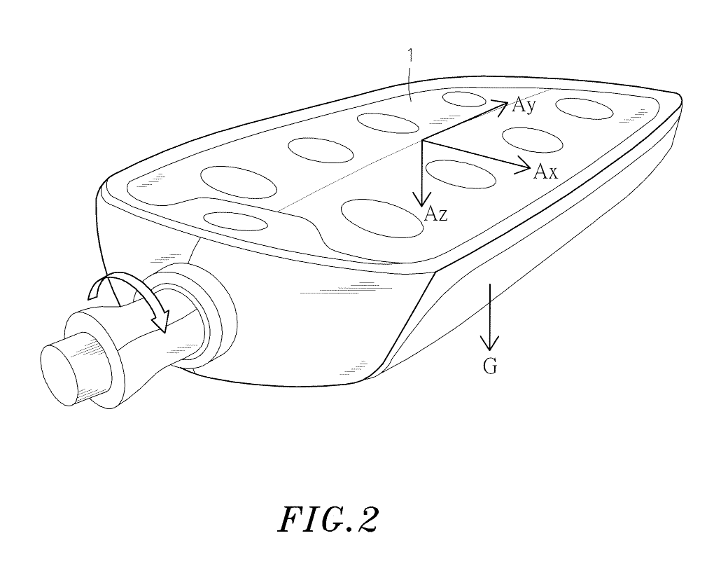

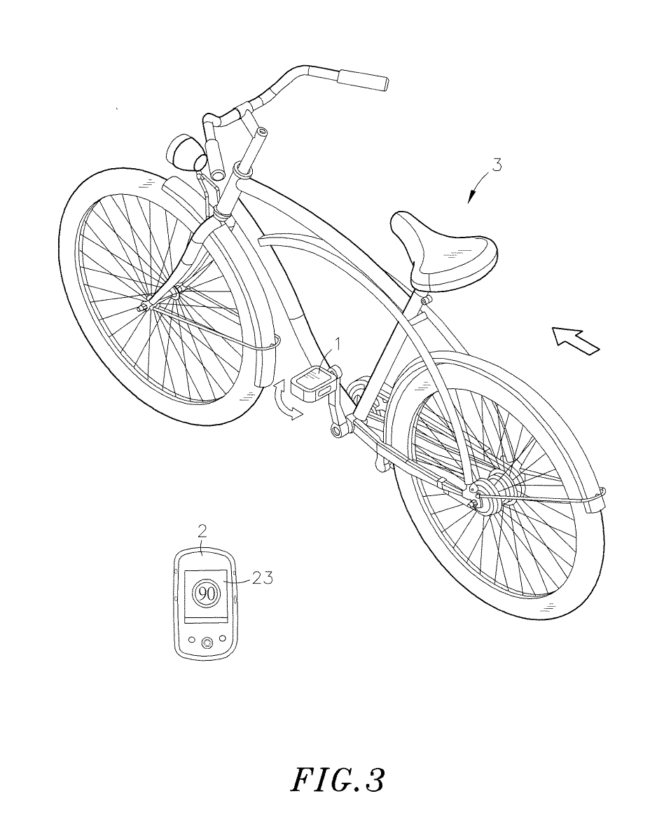

Referring to FIGS. 1, 2 and 3, wherein a block diagram, a diagram for the application on a bicycle pedal as well as a utilization status diagram for a preferred embodiment of the present invention are respectively shown. It can be clearly observed from the Figures that the method for detecting bicycle pedaling frequencies according to the present invention utilizes the body 1 and the electronic device 2, in which:

In a preferred embodiment, the body 1 and the pedal of the bicycle 3 can be directly integrated into one single piece. In practice, however, the body 1 may be also integrated to the interior of a reflection plate (not shown) on the pedal and then installed thereto as a bicycle accessory, or alternatively the body 1 can be further installed to the pedal, inside or outside of the crank by using the positioning element of the shell. An accelerometer 11 can be configured inside the body 1 and connected to a processing unit 12, and the processing unit 12 is also connected to a wireless communication circuit 13 thereby transferring data to the electronic device 2 for receptions. Furthermore, the accelerometer 11, the processing unit 12 and the wireless communication circuit 13 are connected to a power source 14 which may be a button cell battery, lithium battery, dry battery or any other power sources capable of providing electric power; herein the button cell battery provides a feature of reduced volume thus advantageously minimizing the size of the body 1.

The electronic device 2 is preferably a bicycle speedometer, or otherwise a smartphone, smart bracelet or watch, personal digital assistant (PDA) or other terminal appliances. The electronic device 2 includes a control system 21, and the control system 21 is connected to a wireless transmission module 22 and a screen 23. In addition, the control system 21 includes relevant built-in application software thereby allowing to use the wireless transmission module 22 for data receptions and the screen 23 for displaying detection results from the body 1, so the user can promptly appreciate pedaling frequency information during riding the bicycle 3 by way of the electronic device 2, thus appropriately and timely adjusting the pedaling tempos and forces and also maintaining physical conditions and riding efficiency for better practical effects.

In the preferred embodiment for the body 1 set forth as above, the processing unit 12 reads acceleration values from the accelerometer 11 and processes such acceleration values in order to get the pedaling frequency data of the pedal during pedaling in real-time. In practice, however, it is also possible, without calculations, to transfer such values directly through the wireless communication circuit 13 to the wireless transmission module 22 in the electronic device 2 for receptions, and the control system 21 performs processes to acquire the pedaling frequency data. In addition, the processing unit 12 and the wireless communication circuit 13 in the body 1 can be integrated into a system-on-a-chip (SoC) such that the entire circuit design can be minimized and modularized, and the space and volume taken inside the body 1 can be reduced; furthermore, the wireless transmission protocol applied between the wireless communication circuit 13 of the body 1 and the wireless transmission module 22 in the electronic device 2 may be Bluetooth™, ANT or any other wireless transmission protocols customized by the vendors or else commonly applied by other electronic devices 2.

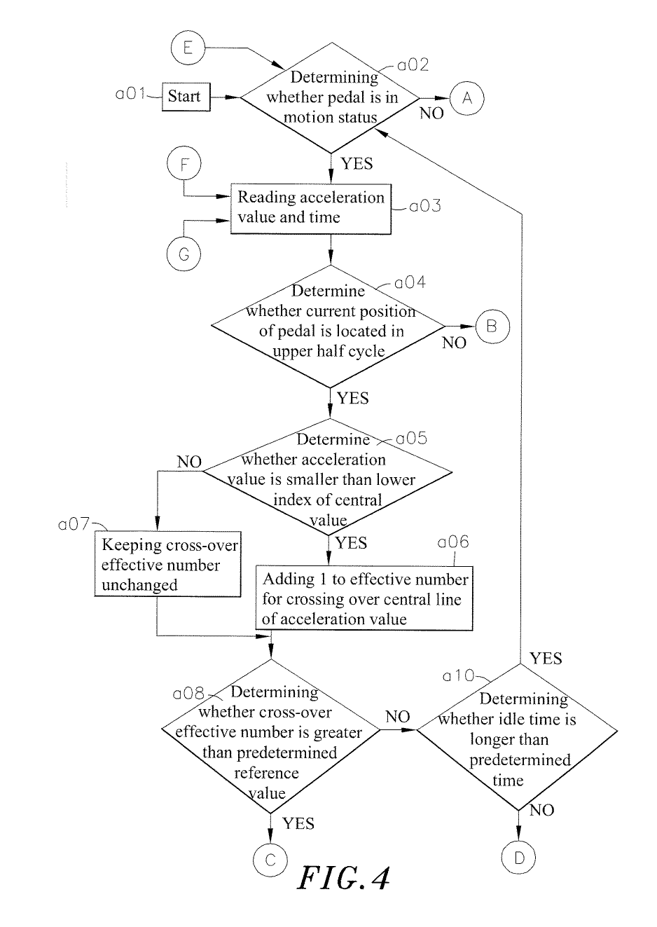

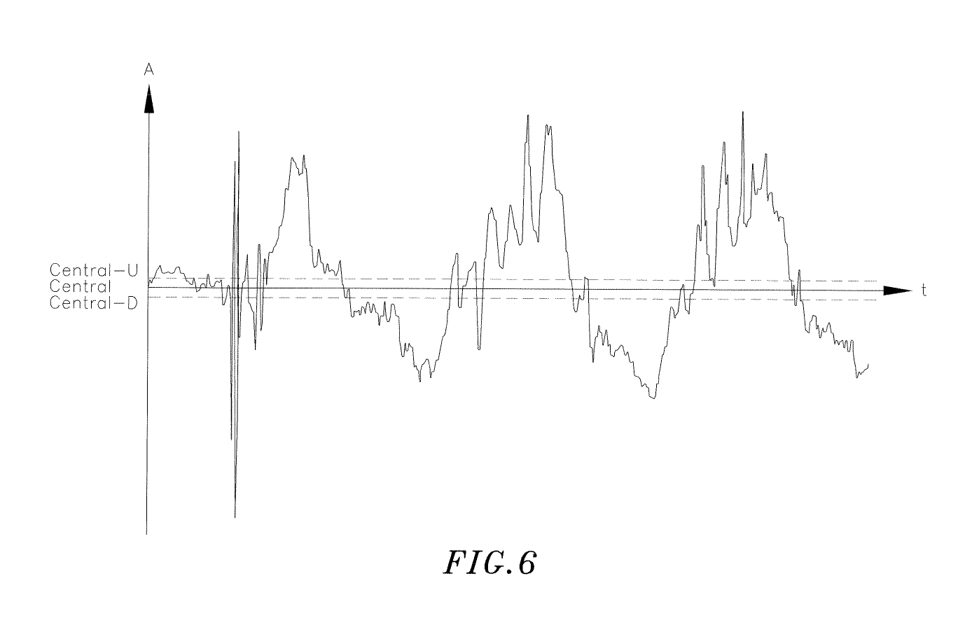

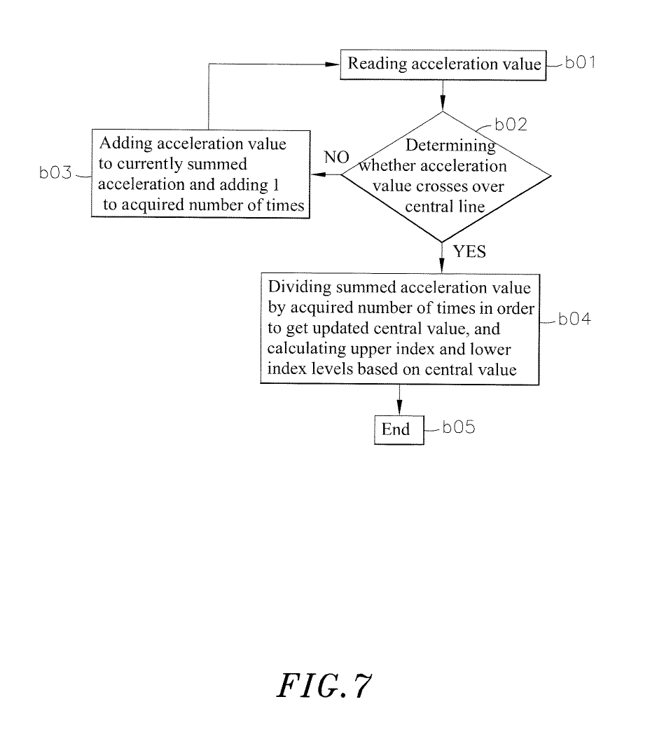

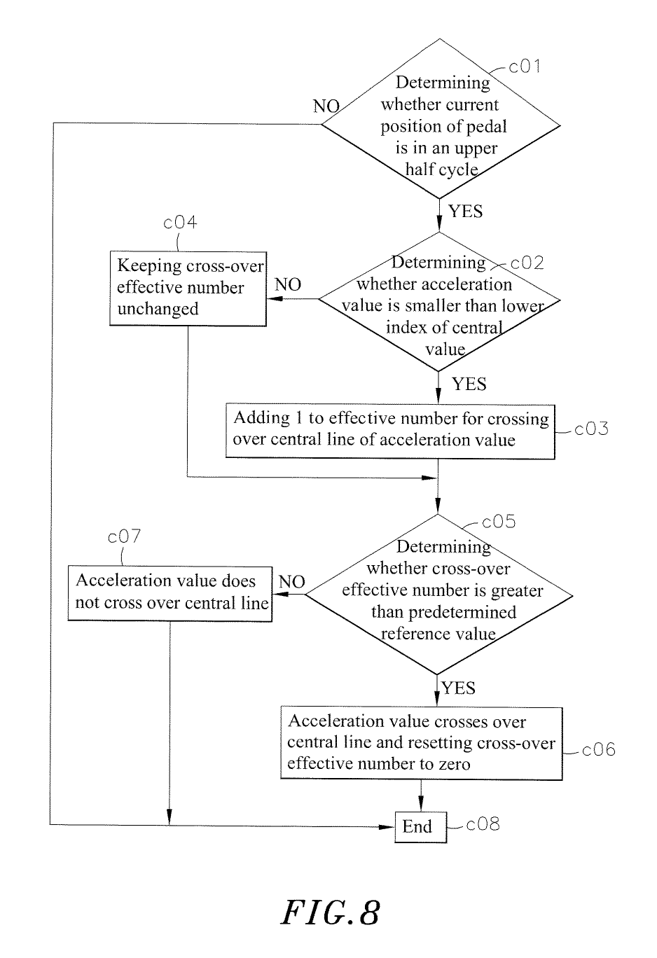

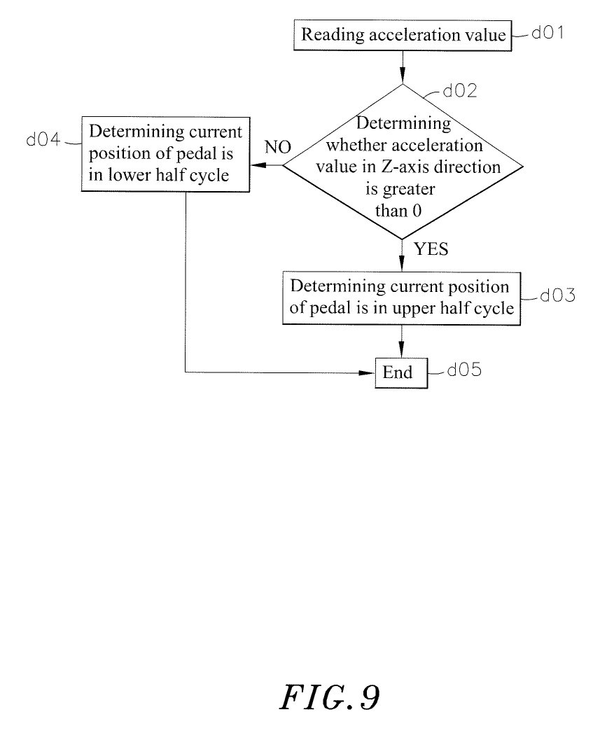

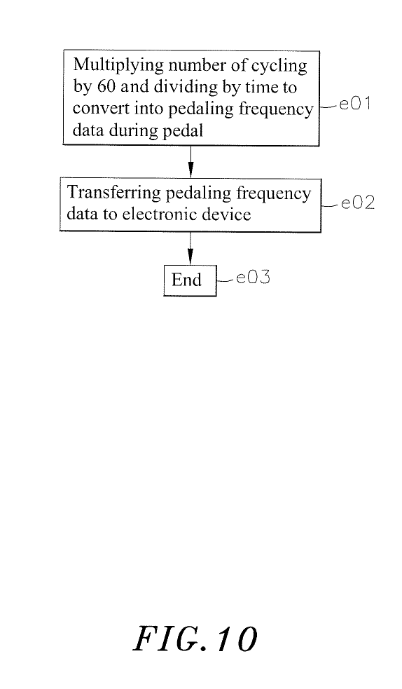

Referring to FIGS. 4 to 10, wherein step flowcharts (1) and (2), a diagram for the acceleration waveform, a step flowchart for updating the central value of the acceleration, a step flowchart for determining whether the acceleration value crosses over the central line, a step flowchart for updating the pedal position and a step flowchart for transferring the pedaling frequency data of the pedal during pedaling according to the present invention are respectively shown. It can be clearly observed from these Figures that, when a user is treading on the pedal of the bicycle 3, it is possible to use the accelerometer 11 of the body 1 to measure acceleration values in at least one axial direction (e.g., in Z-axis), and the processing unit 12 can, based on such acceleration values, generate an acceleration waveform diagram as shown in FIG. 6, in which the horizontal axis indicates time (t) and the vertical axis represents the acceleration (A). For each cycle of the pedal, a corresponding acceleration period is created, and the times that the acceleration waveform crosses over the central line of the acceleration value downwardly from top or upwardly from bottom in a unit time indicates the pedaling frequency.

The application of the method for detecting bicycle pedaling frequencies according to the present invention comprises the following steps:

(a01) Start.

(a02) Determining whether the pedal is in a motion state; if yes, performing STEP (a03), otherwise performing STEP (a17).

(a03) Reading acceleration value and time.

(a04) Determining whether the current position of the pedal is in an upper half cycle; if yes, performing STEP (a05), otherwise performing STEP (a11).

(a05) Determining whether the acceleration value is smaller than the lower index of the central value; if yes, performing STEP (a06), otherwise performing STEP (a07).

(a06) Adding 1 to the effective number for crossing over the central line of the acceleration value, then continuing to perform STEP (a08).

(a07) Keeping the cross-over effective number unchanged, then continuing to perform STEP (a08).

(a08) Determining whether the cross-over effective number is greater than the predetermined reference value; if yes, performing STEP (a09), otherwise performing STEP (a10).

(a09) Writing in the interval time and the number of pedal cycling, and updating the central value of acceleration and the pedal position data, and resetting the cross-over effective number to zero, then continuing to perform STEP (a17).

(a10) Determining whether the idle time is longer than a predetermined time; if yes, repeating STEP (a02), otherwise continuing to perform STEP (a17).

(a11) Determining whether the acceleration value is greater than the upper index of the central value; if yes, performing STEP (a12), otherwise performing STEP (a13).

(a12) Adding 1 to the effective number for crossing over the central line of the acceleration value, then continuing to perform STEP (a14).

(a13) Keeping the cross-over effective number unchanged, then continuing to perform STEP (a14).

(a14) Determining whether the cross-over effective number is greater than the predetermined reference value; if yes, performing STEP (a15), otherwise performing STEP (a16).

(a15) Updating the pedal position data, resetting the cross-over effective number to zero, and then continuing to perform STEP (a17).

(a16) Determining whether the idle time is longer than a predetermined time; if yes, repeating STEP (a02), otherwise continuing to perform STEP (a17).

(a17) Determining whether the status data of the pedal is to be transferred; if yes, performing STEP (a18), otherwise repeating STEP (a03).

(a18) Calculating the pedaling frequency and transferring to the electronic device 2, and then repeating STEP (a03).

In case the pedal of the bicycle 3 according to the present invention is not moving, the central value (Central) of the acceleration waveform as shown in FIG. 6 will become 0 in X-axis direction and the gravity acceleration (G) in Z-axis direction, and peak values in the acceleration waveform of the pedal during pedaling vary along the changes in the pedaling frequency as well. Therefore, in the present invention, two levels are defined and the processing unit 12 is used to identify the fashion the sampled acceleration values cross over the central line so as to prevent erroneous determinations on pedal positions (Position) resulting from, for example, the wave peak suddenly formed due to abrupt acceleration waveforms caused by instantaneous acceleration actions, acceleration value changes because of forward-backward tilting in treading gestures on the pedal, as well as pedal flipping and crossing over the central line, or the like. Herein the upper index of the central value (Cen_U) indicates an interval slightly greater than the central value (i.e., Cen_U=Cen×(1+3%)), while the lower index thereof (Cen_D) indicates an interval slightly smaller than the central value (Cen_D=Cen×(1-3%)).

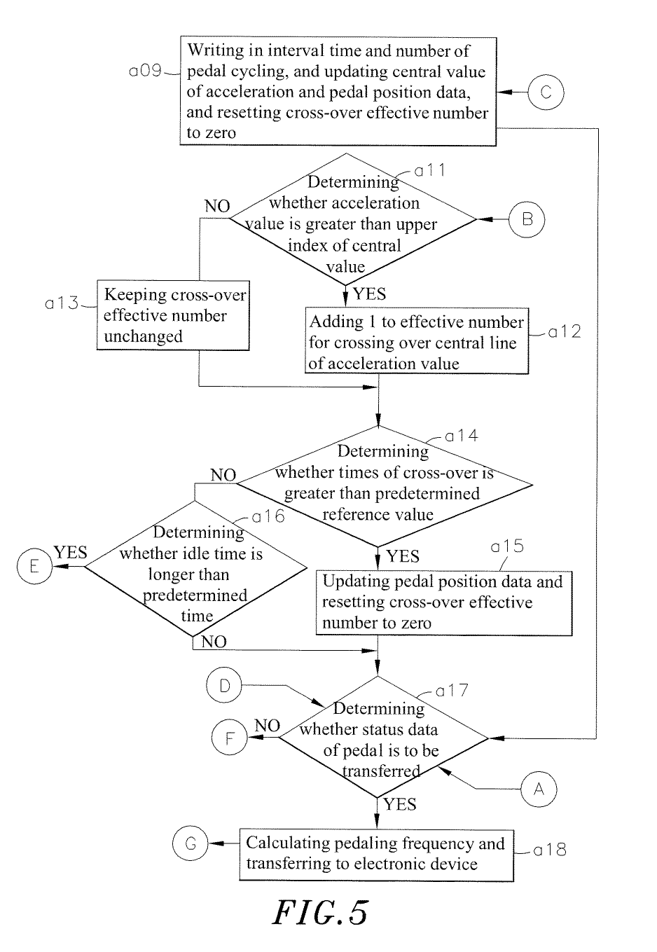

To avoid variations in the acceleration waveform shown in FIG. 6 caused by instantaneous acceleration on the pedal or otherwise due to stopping pedaling, the present invention uses the processing unit 12 to determine whether the pedal crosses over the central line from the upper half cycle of the acceleration waveform down to the lower index within a unit time of a cycle, and takes a reference value as the auxiliary means, as shown in FIG. 5 in the following steps (c01) to (c07). Herein, suppose the pedal is sampled in 4 ms, if the pedaling frequency is less than 50, the reference value is 16 (Cross_Ref=16); if the pedaling frequency is equal to or greater than 50, then the reference value is 10 (Cross_Ref=10); furthermore, when the processing unit 12 determines the number of times for crossing over the lower index becomes greater than a predetermined reference value, it indicates the pedal completes a cycle number; on the other hand, if it has not achieved (i.e., less than or equal to) the predetermined reference value, the pedal may be in a state of being held still or completely stopped.

However, in the aforementioned STEP (a03), the processing unit 12 each time reads the average of 3 data items from the accelerometer 11 thereby reducing possible deviations or errors caused by noise interferences; besides, in the STEP (a04) of the present invention, upon sampling, if the pedal is located in the lower half cycle of the acceleration waveform shown in FIG. 6, or the pedal is in the upper half cycle but turns over, the processing unit 12 performs STEP (a11) shown in FIG. 5 until the pedal changes to the next lower half cycle and then executes STEP (a05) again to perform subsequent pedaling frequency calculations.

In addition, the calculation for updating the central value of acceleration in the aforementioned STEP (a09) according to the present invention comprises the following steps:

(b01) Reading the acceleration value.

(b02) Determining whether the acceleration value crosses over the central line; if yes, performing STEP (b04), otherwise performing STEP (b03).

(b03) Adding the acceleration value to the currently summed acceleration and adding 1 to the acquired number of times, then repeating STEP (b01).

(b04) Dividing the summed acceleration value by the acquired number of times in order to get the updated central value, and then calculating the upper index and lower index levels based on the central value.

From the aforementioned steps, it can be clearly seen that updating the central value of the acceleration includes taking the acceleration values for crossing over the central line downwardly from top and the acceleration values for crossing over the central line downwardly from top during next time, and then using the average of all such sampled acceleration values as the new central value, in which the upper index is defined as the central value plus 3% and the lower index defined as the central value minus 3%.

Moreover, determining whether the acceleration value crosses over the central line in the above-said STEP (b02) comprises the following steps:

(c01) Determining whether the current position of the pedal is in an upper half cycle; if yes, performing STEP (c02), otherwise performing STEP (c08).

(c02) Determining whether the acceleration value is smaller than the lower index of the central value; if yes, performing STEP (c03), otherwise performing STEP (c04).

(c03) Adding 1 to the effective number for crossing over the central line of the acceleration value, then continuing to perform STEP (c05).

(c04) Keeping the cross-over effective number unchanged, then continuing to perform STEP (c05).

(c05) Determining whether the cross-over effective number is greater than the predetermined reference value; if yes, performing STEP (c06), otherwise performing STEP (c07).

(c06) Determining that the acceleration value crosses over the central line, resetting the cross-over effective number to zero, and then continuing to perform STEP (c08).

(c07) Determining that the acceleration value does not cross over the central line, and continuing to perform STEP (c08).

(c08) End.

From the aforementioned steps, it can be clearly seen that determining whether the acceleration value crosses over the central line includes, in case of 4 ms sampling frequency for the pedal downwardly from upper half cycle, determining that the acceleration value crosses over the central line if the effective number for the acceleration value being smaller than the lower index of the central value is greater than the predetermined reference value.

However, updating the pedal position in the above-said STEPs (a09) and (a15) comprises the following steps:

(d01) Reading the acceleration value.

(d02) Determining whether the acceleration value in the Z-axis direction is greater than 0; if yes, performing STEP (d03), otherwise performing STEP (d04).

(d03) Determining the current position of the pedal is in the upper half cycle, and continuing to perform STEP (d05).

(d04) Determining the current position of the pedal is in the lower half cycle, and continuing to perform STEP (d05).

(d05) End.

In the above-said STEP (d02), if the pedal is held still, the central value of the acceleration in Z-axis direction is the gravity, i.e., 1G, and, upon pedaling, the wave peaks and volleys of the acceleration may vary along the pedaling frequency; that is, the faster the pedaling frequency is, the greater the absolute value of the peak value becomes. Suppose the acceleration value of the pedal in Z-axis direction is greater than the central value of the acceleration in the simple harmonic motion, it can be determined the pedal is currently located in the upper half cycle; otherwise, the pedal position may be determined to be in the lower half cycle.

Furthermore, in STEP (a18), transferring pedaling frequency data of the pedal during pedaling comprises the following steps:

(e01) Multiplying the number of cycling by 60 and dividing it by time in order to convert into the pedaling frequency data of the pedal.

(e02) Transferring the pedaling frequency data to the electronic device 2.

(e03) End.

It can be clearly seen from aforementioned steps that, as transferring pedaling frequency data of the pedal during pedaling, the number of pedal cycling is converted into pedaling frequency per minute, encoded based on the communication protocol used by the wireless communication circuit 13, and then transferred to the electronic device 2 for receptions thereby displaying the pedaling frequency data on the screen 23 in real-time.

The aforementioned detailed descriptions have been set forth merely with regards to a preferred embodiment of the present invention, but the illustrated embodiment is by no means intended to restrict the scope of the present invention. Accordingly, all other effectively equivalent changes, modifications and alternations made without departing from the scope and spirit of the present invention should be considered as falling within the coverage defined hereunder by the claims of the present invention.

What is claimed is:

1. A method for detecting bicycle pedaling frequencies, which uses an accelerometer configured in the body and connected to a processing unit, in which the processing unit is connected to a wireless communication circuit for transmitting data to an electronic device so as to display the pedaling data and the processing unit determines the acceleration value acquired by the accelerometer thereby calculating the number of times that the acceleration waveform crosses over a central line from the upper half cycle per minute as the pedaling frequency, the method comprising the following steps:
(a01) Start;
(a02) Determining whether the pedal is in a motion state; if yes, performing STEP (a03), otherwise performing STEP (a17);
(a03) Reading acceleration value and time;
(a04) Determining whether the current position of the pedal is in an upper half cycle; if yes, performing STEP (a05), otherwise performing STEP (a11);
(a05) Determining whether the acceleration value is smaller than the lower index of the central value; if yes, performing STEP (a06), otherwise performing STEP (a07);
(a06) Adding 1 to the effective number for crossing over the central line of the acceleration value, then continuing to perform STEP (a08);
(a07) Keeping the cross-over effective number unchanged, then continuing to perform STEP (a08);
(a08) Determining whether the cross-over effective number is greater than the predetermined reference value; if yes, performing STEP (a09), otherwise performing STEP (a10);
(a09) Writing in the interval time and the number of pedal cycling, and updating the central value of acceleration and the pedal position data, and resetting the cross-over effective number to zero, then continuing to perform STEP (a17);
(a10) Determining whether the idle time is longer than a predetermined time; if yes, repeating STEP (a02), otherwise continuing to perform STEP (a17);
(a11) Determining whether the acceleration value is greater than the upper index of the central value; if yes, performing STEP (a12), otherwise performing STEP (a13);
(a12) Adding 1 to the effective number for crossing over the central line of the acceleration value, then continuing to perform STEP (a14);
(a13) Keeping the cross-over effective number unchanged, then continuing to perform STEP (a14);
(a14) Determining whether the cross-over effective number is greater than the predetermined reference value; if yes, performing STEP (a15), otherwise performing STEP (a16);
(a15) Updating the pedal position data, resetting the cross-over effective number to zero, and then continuing to perform STEP (a17);
(a16) Determining whether the idle time is longer than a predetermined time; if yes, repeating STEP (a02), otherwise continuing to perform STEP (a17);
(a17) Determining whether the status data of the pedal is to be transferred; if yes, performing STEP (a18), otherwise repeating STEP (a03);
(a18) Calculating the pedaling frequency and transferring to the electronic device, and then repeating STEP (a03).

2. The method for detecting bicycle pedaling frequencies according to claim 1, wherein updating the central value of the acceleration in STEP (a09) further comprises the following steps:
(b01) Reading the acceleration value;
(b02) Determining whether the acceleration value crosses over the central line; if yes, performing STEP (b04), otherwise performing STEP (b03);
(b03) Adding the acceleration value to the currently summed acceleration and adding 1 to the acquired number of times, then repeating STEP (b01);
(b04) Dividing the summed acceleration value by the acquired number of times in order to get the updated central value and then calculating the upper index and lower index levels based on the central value.

3. The method for detecting bicycle pedaling frequencies according to claim 2, wherein updating the central value of the acceleration includes taking the acceleration values for crossing over the central line downwardly from top and the acceleration values for crossing over the central line downwardly from top during next time, and then using the average of all such sampled acceleration values as the new central value, in which the upper index is defined as the central value plus 3% and the lower index defined as the central value minus 3%.

4. The method for detecting bicycle pedaling frequencies according to claim 2, wherein determining whether the acceleration value crosses over the central line in STEP (b02) further comprises the following steps:
(c01) Determining whether the current position of the pedal is in an upper half cycle; if yes, performing STEP (c02), otherwise performing STEP (c08);
(c02) Determining whether the acceleration value is smaller than the lower index of the central value; if yes, performing STEP (c03), otherwise performing STEP (c04);
(c03) Adding 1 to the effective number for crossing over the central line of the acceleration value, then continuing to perform STEP (c05);
(c04) Keeping the cross-over effective number unchanged, then continuing to perform STEP (c05);
(c05) Determining whether the cross-over effective number is greater than the predetermined reference value; if yes, performing STEP (c06), otherwise performing STEP (c07);
(c06) Determining that the acceleration value crosses over the central line, resetting the cross-over effective number to zero, and then continuing to perform STEP (c08);
(c07) Determining that the acceleration value does not cross over the central line, and continuing to perform STEP (c08);
(c08) End.

5. The method for detecting bicycle pedaling frequencies according to claim 4, wherein determining whether the acceleration value crosses over the central line includes, in case of 4 ms sampling frequency for the pedal downwardly from upper half cycle, determining that the acceleration value crosses over the central line if the effective number for the acceleration value being smaller than the lower index of the central value is greater than the predetermined reference value.

6. The method for detecting bicycle pedaling frequencies according to claim 1, wherein updating the pedal position in STEPs (a09) and (a15) further comprises the following steps:
(d01) Reading the acceleration value;
(d02) Determining whether the acceleration value in the Z-axis direction is greater than 0; if yes, performing STEP (d03), otherwise performing STEP (d04);
(d03) Determining the current position of the pedal is in the upper half cycle, and continuing to perform STEP (d05);
(d04) Determining the current position of the pedal is in the lower half cycle, and continuing to perform STEP (d05);
(d05) End.

7. The method for detecting bicycle pedaling frequencies according to claim 6, wherein updating the pedal position includes determining the pedal position is in the upper half cycle if the acceleration value in Z-axis direction during pedaling is greater than 0.

8. The method for detecting bicycle pedaling frequencies according to claim 1, wherein, upon transferring the pedaling frequency data of the pedal during pedaling in STEP (a18), the cycling number of the pedal is converted into pedaling frequency per minute, encoded in accordance with the communication protocol applied in the wireless communication circuit and then transferred to the electronic device for reception so as to display the pedaling frequency data.

9. The method for detecting bicycle pedaling frequencies according to claim 1, wherein the body and the pedal of the bicycle are directly integrated into one piece.

10. The method for detecting bicycle pedaling frequencies according to claim 1, wherein the body is integrated to the interior of the reflection plate on the bicycle pedal thereby allowable to be installed as an accessory in use.

11. The method for detecting bicycle pedaling frequencies according to claim 1, wherein the positioning element of the shell can be further used for installing the body onto the pedal, the interior of crank or the exterior of the bicycle.

12. The method for detecting bicycle pedaling frequencies according to claim 1, wherein the accelerometer, the processing unit and the wireless communication circuit of the body are connected to a power source which may be a button cell battery, a lithium battery or a dry battery.

13. The method for detecting bicycle pedaling frequencies according to claim 1, wherein the electronic device includes a control system which is connected to a wireless transmission module and a screen thereby displaying the pedaling frequency data transferred from the body.

14. The method for detecting bicycle pedaling frequencies according to claim 13, wherein the wireless transmission protocol utilized by the wireless communication circuit of the body and the wireless transmission module of the electronic device is Bluetooth™ or ANT.
